(19) United States
(12) Patent Application Publication
(10) Pub. No.: US 2008/0282092 A1
(43) Pub. Date: Nov. 13, 2008

(54) Card reading apparatus with integrated identification function

(76) Inventors: Chih Kang Pan, Taipei City (TW); Yao-Shun Hung, Taipei City (TW); Hsiang-Chi Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,192

(22) Filed: May 11, 2007

(51) Int. Cl. H04L 9/32

(52) U.S. Cl. 713/186; 713/182

(57) ABSTRACT

A card reading apparatus integrating identification function is provided, including a USB interface, a memory card interface, an ATA/ATAPI interface, a USB OTG controller, an identification interface module, an encrypted identification processor, and at least an identification device. The USB interface, the memory card interface, and the ATA/ATAPI interface are connected respectively to a USB interface media device, a flash memory card, and a data storage device, such as hard disk or CD-RW. The USB OTG controller is connected to the USB interface, the memory card interface, and the ATA/ATAPI interface so that the USB interface media device, the flash memory card, and the data storage device can exchange data under the control of the USB OTG controller. The identification interface module is connected to the USB OTG controller, the encrypted identification processor is connected to the identification interface module, and the identification device is connected to the encrypted identification processor. Therefore, the identification device can use fingerprint, other biological identification data or magnetic card to transmit the identification data to the encrypted identification processor. The results from the encrypted identification processor are used to enable and disable the USB OTG controller so that the stored data can be protected by encrypted identification function.

### BACKGROUND OF THE INVENTION

1. Field of the Invention

The present invention relates to an integrated card reading apparatus with identification function and, more particularly, to a flash memory card reading apparatus that can connect data storage for multi-directional data transmission, data storage and encrypted identification functions.

2. The Related Arts

The conventional USB on-the-go (OTG) devices, such as data bank, usually include one or two USB ports for connecting to USB devices, and use an IDE port for connecting a hard disk so that the data on the USB device connected to the USB port, such as portable disk, can be copied to the hard disk for storage. In addition, most card readers, such as interfaces for SD memory card, multi-media card (MMC), and memory stick card, only support one-way data copying. That is copying data in the flash memory card to the hard disk.

The conventional USB OTG devices usually do not support reversed data transfer, for example, copying data in the hard disk or the flash memory connected with the card reader to the USB devices. To accomplish this, a desktop personal computer or a notebook computer is usually required to perform the data transfer from the hard disk or the flash memory card connected with the card readers. It is inconvenient and time-consuming for the users.

The conventional USB OTG devices usually only support a few types of memory card interfaces and one-way data copying, and thus the usability is limited. This also restricts the usability of USB devices, such as portable disks.

Furthermore, the data in the data storage devices connected to the conventional USB OTG devices, such as portable disks, hard disks, flash memories, are usually important and confidential. The conventional USB OTG devices do not provide any encrypted identification function to prevent the unauthorized use or copy of the data.

### SUMMARY OF THE INVENTION

The present invention has been made to overcome the above drawbacks of the conventional card reading apparatus. The primary object of the present invention is to provide a card reading apparatus integrated with identification function, comprising a USB interface, a memory card interface, an ATA/ATAPI interface, and a USB OTG controller. The USB OTG controller is connected to the USB interface, the memory card interface and the ATA/ATAPI interface so that the USB media device connected to the USB interface, the flash memory cards connected to the memory card interface and the data storage devices, such as hard disk and CD-R/W, connected to the ATA/ATAPI interface can all perform multi-directional data transfer among themselves.

Another object of the present invention is to provide a card reading apparatus integrated with identification function, including an identification interface module, an encrypted identification processor, and at least an identification device. The identification interface module is connected to the USB OTG controller, the encrypted identification processor is connected to the identification interface module, and the identification device is connected to the encrypted identification processor. Therefore, the identification device can use fingerprint, other biological identification data or magnetic card to transmit the identification data to the encrypted identification processor. The results from the encrypted identification processor are used to determine the ON/OFF of the USB OTG controller so that the stored data can be protected by encrypted identification function.

To achieve the above objects, the present invention provides a card reading apparatus integrating identification function, comprising a USB interface, a memory card interface, an ATA/ATAPI interface, an USB OTG controller, an identification interface module, an encrypted identification processor, and at least an identification device. The USB interface, memory card interface and ATA/ATAPI interface are connected respectively to a USB interface media device, a flash memory card and a data storage device, such as hard disk or CD-RW. The USB OTG controller is connected to the USB interface, memory card interface and ATA/ATAPI interface so that the USB interface media device, flash memory card, and the data storage device can exchange data under the control of the USB OTG controller. The identification interface module is connected to the USB OTG controller, the encrypted identification processor is connected to the identification interface module, and the identification device is connected to the encrypted identification processor. Therefore, the identification device can use fingerprint, other biological identification data or magnetic card to transmit the identification data to the encrypted identification processor. The results from the encrypted identification processor are used to determine the ON/OFF of the USB OTG controller so that the stored data can be protected by encrypted identification function.

These and other objects, features and advantages of the invention will be apparent to those skilled in the art, from a reading of the following brief description of the drawings, the detailed description of the preferred embodiments, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system function block diagram of a first embodiment of the present invention;

FIG. 2 is a system function block diagram of a second embodiment of the present invention; and

FIG. 3 is a system function block diagram of a third embodiment of the present invention.

### DETAILED DESCRIPTION OF THE PREFERRED EMBODIMENTS

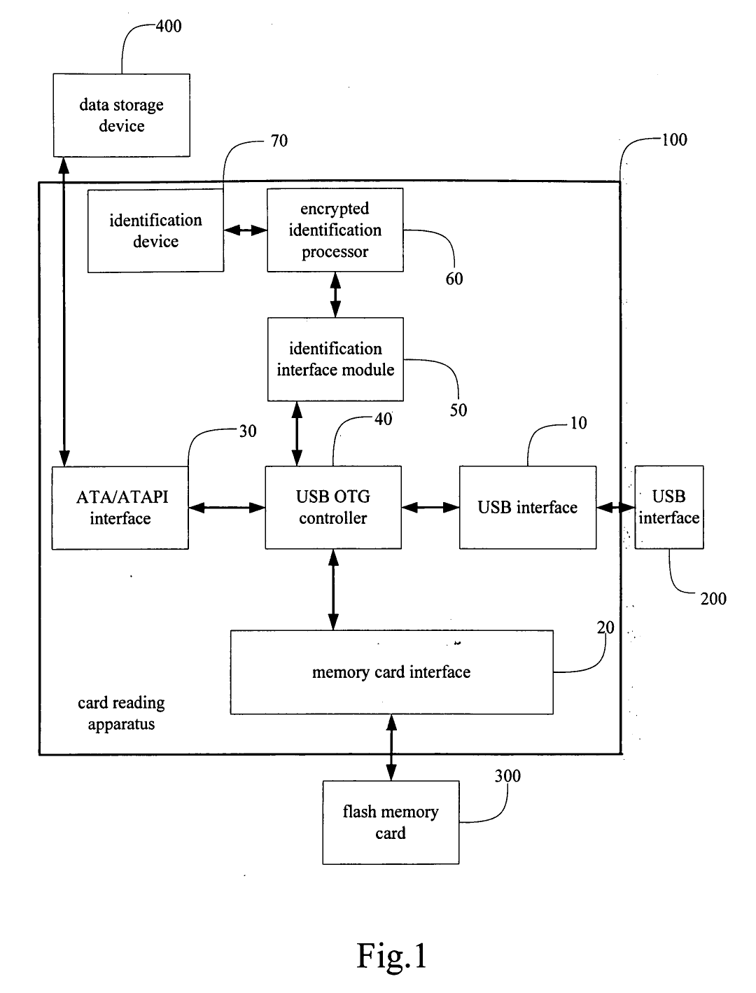

With reference to the drawings and in particular to FIG. 1, which shows a system functional block diagram in accordance with a first embodiment of the present invention, a card reading apparatus 100 comprises a USB interface 10, a memory card interface 20, an ATA/ATAPI interface 30, a USB OTG controller 40, an identification interface module 50, an encrypted identification processor 60, and at least an identification device 70. The USB interface 10 provides connection to a USB interface device 200. The USB interface 200 is not limited to any specific type. The present invention uses a portable disk as an embodiment for explanation. Other USB interface devices, such as digital camera, mobile phone, MP3 player, digital video camera, PDA, and recording pen, are also within the scope of the present invention.

The memory card interface 20 provides connection to a flash memory card 300. The flash memory card 300 is not limited to any specific type. The present invention uses an SD flash memory card as an embodiment for explanation. Other flash memory cards, such as MMC, CF, SM, and XD-Picture, are also within the scope of the present invention.

The ATA/ATAPI interface 30 provides connection to a data storage device 400. The data storage device 400 is not limited to any specific type. The present invention uses a hard disk as an embodiment for explanation. Other data storage devices, such as CD-RW, are also within the scope of the present invention.

The USB OTG controller 40 is connected to the USB interface 10, the memory card interface 20, and the ATA/ATAPI interface 30. The USB OTG controller 40 provides bi-directional data transmission, storage, and application functions for at least two different data media. Therefore, the USB interface device 200 connected to the USB interface 10, the flash memory card 300 connected to the memory card interface 20, and the data storage device 400 connected to the ATA/ATAPI interface 30 can perform multi-direction data transmission, storage, and application functions under the control of the USB OTG controller 40. For example, the data stored in the flash memory card 300 connected to the memory card interface 20 can be transmitted to the USB interface device 200 connected to the USB interface 10 for storage or application. Similarly, the data stored in the data storage device 400 connected to the ATA/ATAPI interface 30 can be transmitted to the flash memory card 300 connected to the memory card interface 20 for storage or application, and then the data can further be transmitted from the flash memory card 300 connected to the memory card interface 20 to the USB interface device 200 connected to the USB interface 10 for further storage or application. The transmission path is not limited to any specific route. Other transmission path, storage and application functions are also within the scope of the present invention.

The identification interface module 50 is connected to the USB OTG controller 40 for acting as connection interface of the USB OTG controller 40. The encrypted identification processor 60 is connected to the identification interface module 50. The encrypted identification processor 60 identifies an encrypted identification data, such as fingerprint, other biological identification data, or magnetic card, by comparing the pre-installed encrypted identification data in the encrypted identification processor 60. The identification device 70 is connected to the encrypted identification processor 60. The identification device 70 is not limited to any specific type. The present invention uses a fingerprint identification device as an embodiment for explanation. Other types of identification devices are also within the scope of the present invention. Identification device 70 transmits the identification data input by the user to the encrypted identification processor 60 for identification, and sends an enable or a disable signal through the identification interface module 50 to the USB OTG controller 40 according to the identification results to enable or disable the USB OTG controller 40. Therefore, the USB OTG 50 can control the data transmission, storage, and application functions among the USB interface device 200 connected to the USB interface 10, the flash memory card 300 connected to the memory card interface 20, and the data storage device 400 connected to the ATA/ATAPI interface 30 according to the identification results to prevent from unauthorized use.

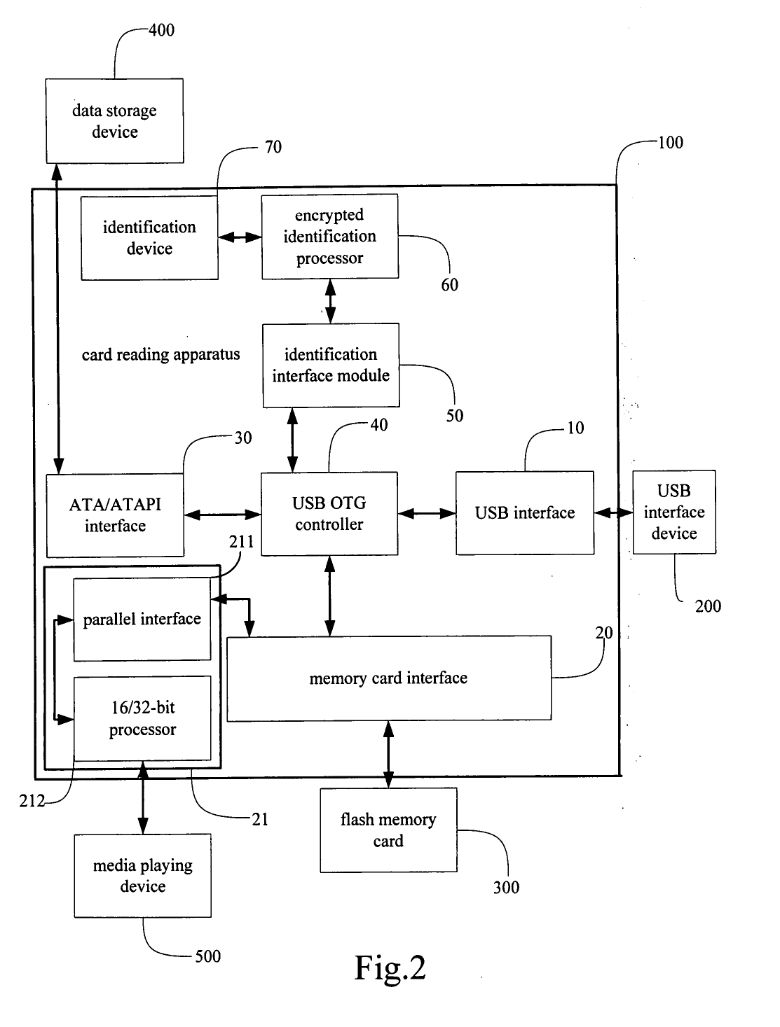

FIG. 2 shows a system functional block diagram in accordance with a second embodiment of the present invention, where the memory card interface 20 is connected to a parallel interface module 21. The parallel interface module 21 comprises a parallel interface 211 and a 16/32-bit processor 212. The parallel interface 211 is connected to the memory card interface 20, and the 16/32-bit processor 212 is connected to a media playing device 500. The media playing device 500 is not limited to any specific type. The present invention uses a digital TV as an embodiment for explanation. Other media playing devices, such as DVD player, MP3 player and 3G mobile phone, are also within the scope of the present invention.

The media playing device 500 can use the data transmission, storage, and application fiction among the USB interface device 200 connected to the USB interface 10, the flash memory card 300 connected to the memory card interface 20, and the data storage device 400 connected to the ATA/ATAPI interface 30 to play and apply the media data stored in the USB interface device 200, the flash memory card 300, and the data storage device 400.

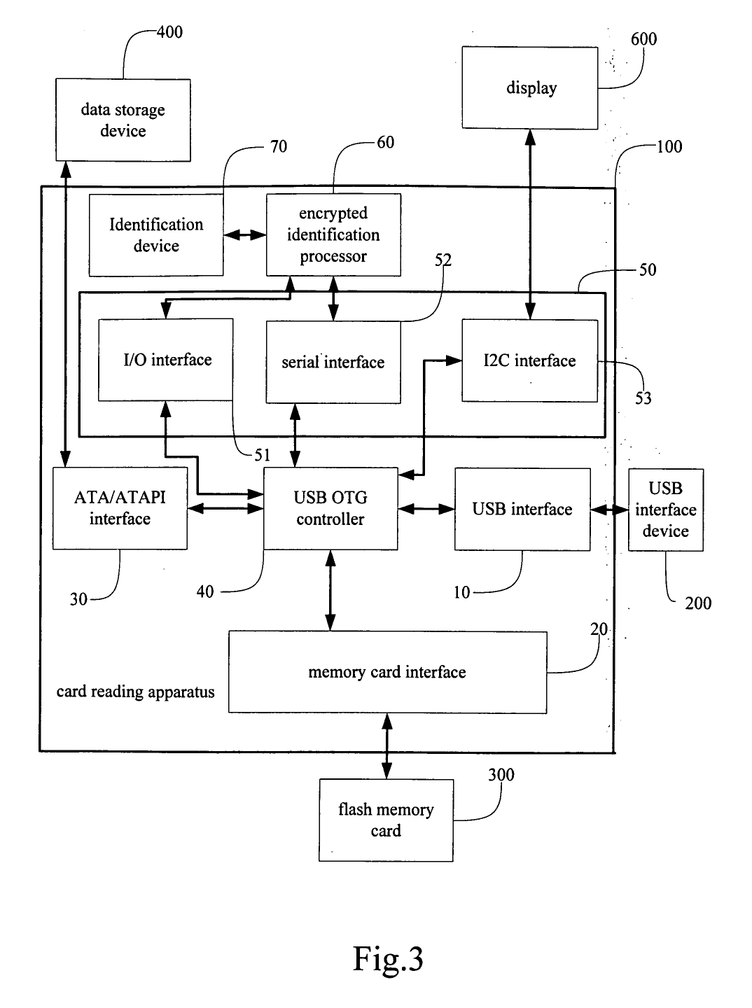

FIG. 3 shows a system functional block diagram in accordance with a third embodiment of the present invention, where the identification interface module 50 comprises an I/O interface 51, a serial interface 52, and an I2C interface 53. The I/O interface 51 and the serial interface 52 are connected to the USB OTG controller 40 and the encrypted identification processor 60. The I2C interface 53 is connected to the USB OTG controller 40 and a display 600. The display 600 is not limited to any specific type. The present invention uses an LCD as embodiment for explanation. The display 600 is for displaying the status information of the data transmission, storage, and application function among the USB interface device 200 connected to the USB interface 10, the flash memory card 300 connected to the memory card interface 20, and the data storage device 400 connected to the ATA/ATAPI interface 30, as well as the identification status information of the identification device 70.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. A card reading and identification apparatus, comprising:
a USB interface, connecting a USB interface device;
a memory card interface, connecting a flash memory card;
an ATA/ATAPI interface, connecting a data storage device;
a USB controller, connecting the USB interface, the memory card interface and the ATA/ATAPI interface for providing data transmission, storage, and application among the USB interface device connected to the USB interface, the flash memory card connected to the memory card interface, and the data storage device connected to the ATA/ATAPI interface;
an identification interface module, connecting to the USB OTG controller;
an encrypted identification processor, connecting to the identification interface module for processing identification data and sending control signals through the identification interface module to the USB OTG controller for selectively enabling and disabling the USB OTG controller according to the identification results; and
an identification device, connecting to the encrypted identification processor for inputting identification data to the encrypted identification processor.

2. The apparatus as claimed in claim 1, wherein the USB interface is connected to a portable disk.

3. The apparatus as claimed in claim 1, wherein the memory card interface is connected to an SD flash memory card.

4. The apparatus as claimed in claim 1, wherein the memory card interface is connected to a parallel interface module.

5. The apparatus as claimed in claim 4, wherein the parallel interface module further comprises:
an interface module, connecting to the memory card interface; and
a 16/32-bit processor, connecting to a media playing device.

6. The apparatus as claimed in claim 5, wherein the 16/32-bit processor is connected to a digital TV.

7. The apparatus as claimed in claim 1, wherein the ATA/ATAPI interface is connected to a hard disk.

8. The apparatus as claimed in claim 1, wherein the identification interface module further comprises:
an I/O interface, connecting the USB OTG controller;
a serial interface, connecting the USB OTG controller; and
an I2C interface, connecting the USB OTG controller and a display.

9. The apparatus as claimed in claim 8, wherein the display is an LCD.

10. The apparatus as claimed in claim 1, wherein the identification device is a fingerprint identification device.
